(19) United States
(12) Patent Application Publication
(10) Pub. No.: US 2014/0149937 A1
(43) Pub. Date: May 29, 2014

(54) VISUAL MEAL CREATOR

(71) Applicant: UNIVERSITY OF BIRMINGHAM, BIRMINGHAM (GB)

(72) Inventors: ADRIAN HOLLIDAY, BIRMINGHAM (GB); ANDREW BLANNIN, BIRMINGHAM (GB)

(73) Assignee: UNIVERSITY OF BIRMINGHAM, BIRMINGHAM (GB)

(21) Appl. No.: 14/089,396

(22) Filed: Nov. 25, 2013

Related U.S. Application Data
(60) Provisional application No. 61/729,739, filed on Nov. 26, 2012.

(51) Int. Cl. G06F 3/0482

(52) U.S. Cl. CPC G06F 3/0482
USPC 715/815; 715/835

(57) ABSTRACT

Technologies are generally described for devices, methods and systems effective to create a visual display of a meal. A processor may be configured in communication with a memory. The processor may be effective to display images of food items on a display. The processor may be further configured to receive one or more selections of food items from among the displayed images. The processor may be further configured to display images of the one or more selected food items on the display to generate the visual display of the meal. The processor may be further configured to calculate an amount of energy associated with the displayed meal.

### CROSS-REFERENCE TO RELATED APPLICATIONS

This application claims priority to provisional application No. 61/729,739 filed Nov. 26, 2012 entitled “VISUAL MEAL CREATOR”, the entirety of which is hereby incorporated by reference.

### TECHNICAL FIELD

This application relates to a computer-based tool for creating a visual image of a meal, and more particularly to such a tool for use in assessing a user's appetite.

### BACKGROUND

Long term weight management intervention strategies may be used by individuals seeking to adjust their weight. Such strategies may use methods for promoting a negative energy balance. A negative energy balance may result from expending more energy than is consumed in the form of food. Effective and sustainable long term strategies that provide prolonged or repeated periods of negative balance may result in weight loss. Appetite regulation may be one method of promoting a sustainable negative energy balance.

### BRIEF DESCRIPTION OF THE DRAWINGS

FIG. 1 is a schematic illustration of the components of a computer-based tool for implementing a visual meal creator.

FIG. 2 illustrates an example of a menu of food items displayed on a screen.

FIG. 3 illustrates an example of a screen display of selected food items on a meal plate.

FIG. 4 is a flow chart illustrating a visual meal creation procedure.

### DETAILED DESCRIPTION

A computer-based visual meal creator for the measurement of a subject's appetite is generally described. The visual meal creator may enable a user to construct a meal that the subject would wish to consume from a library, or menu, of food images.

The visual meal creator may include a processor, a memory configured in communication with the processor and one or more instructions executable by the processor. The memory may be configured to store the one or more instructions. The processor may be effective to display images of food items on a display, in accordance with the one or more instructions. The processor may be further configured to, in accordance with the one or more instructions, receive one or more selections of food items from among the displayed images. The processor may be further configured to, in accordance with the one or more instructions, display images of the one or more selected food items on the display to generate the visual display of the meal. The processor may be further configured to, in accordance with the one or more instructions, calculate an amount of energy associated with the displayed meal.

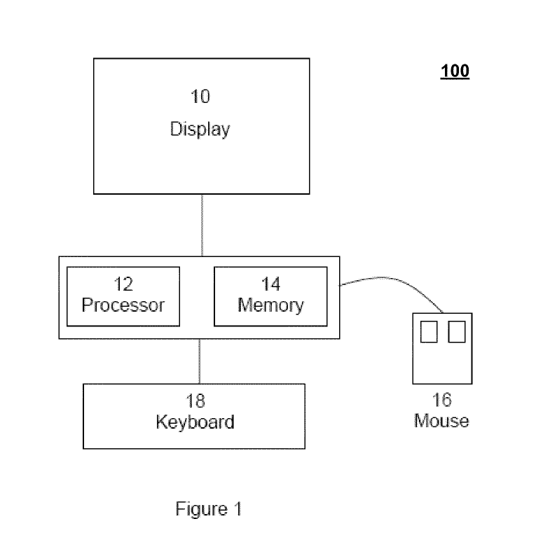

FIG. 1 is a schematic illustration of the components of the computer-based tool, and includes a display screen 10, a processor 12, a memory 14 and a user input that includes a displayed item selection device 16 such as a mouse and/or a keyboard 18. Memory 14 may store data and one or more instructions executable by the processor 12. The data in the memory 14 includes image data of food items which can be displayed on the display screen 10. The one or more instructions configure the processor 12 to respond to a user selecting, by use of the selection device 18, one or more displayed food items to generate a visual display of a meal containing the selected items. Note that although FIG. 1 illustrates the components as separate connected components, two or more (or all) of these may be incorporated into a single device. For example, all of the components may be built into a single computing device, such as a laptop computer, or into a hand-held or mobile device such as a mobile phone.

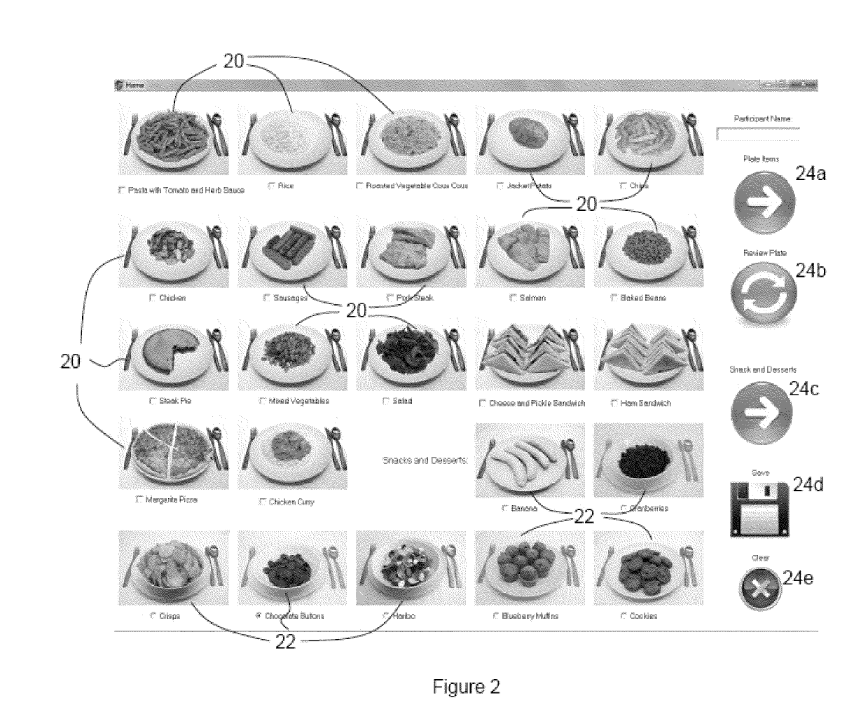

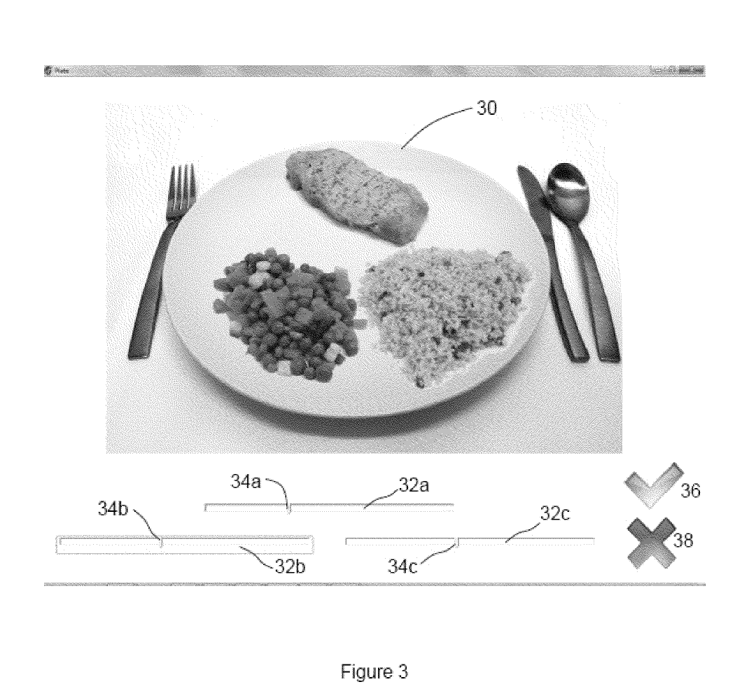

FIG. 2 illustrates an example of a menu of food items 20 and snacks and desserts 22 which may be displayed on a screen such as display screen 10 of FIG. 1. The menu may include images of food items 20 and images of snacks and desserts 22. Buttons 24a-e may be included in the display. Buttons 24a-e may be clicked on to perform various functions, as described below. The user may manipulate the selection device to select any desired food items 20 from the menu. Selected food items may then appear on a meal plate 30, as shown in FIG. 3. For example, the user may manipulate a mouse to position a cursor over one or more (typically up to four) of the food items 20. The user may click on the one or more food items 20 to highlight the item(s). The user may then select the highlighted item(s) by clicking on or otherwise selecting arrow button 24a. A portion (portions) of the selected food item(s) 20 will then appear on meal plate 30. In an example, the visual display of the meal may include an amount of each selected food items based on a user input quantity. As will be discussed in further detail below, the amount of each selected food item may be adjusted after it appears on meal plate 30. In another example, an amount may be represented by a weight of the selected food item 20. The weight of the food item 20 may be displayed to a user and may be adjustable. Snack and dessert items 22 may also be selected. Snack and dessert items 22 may be selected separately by highlighting desired snack and desert items and then clicking on or otherwise selecting the arrow button 24c. Snack and dessert items 22 may be pictured on meal plate 30 or on a separate plate for snack and dessert items 22.

For each food item 20, there may be a large library of images (e.g. 40-60 photographic images) of ascending portion size. Each portion size may include a known weight. The energy density of a particular food item 20 may be associated with that food item 20. As illustrated in FIG. 3, the portion size of each individual food item 20 may be manipulated to meet the user's desire. In the illustrated embodiment, portion sizes are manipulated using a sliding bar scale 32a, 32b, 32c for each selected food item 20. Sliding bars 34a, 34b, 34c may be moved along the respective scale (e.g., from left to right) using the mouse 16 (or keyboard 18 arrow keys) in order to increase the portion size of the image of the food item on the screen. Sliding bars 34a, 34b, 34c may also be moved backwards (e.g., from right to left) to decrease the portion size. Portions of snack and dessert items 22 may be adjusted in a similar manner to the portions of food items 20.

In an example, sliding bar scale 32a may be configured to manipulate the portion size of the vegetable (peas and carrots) food item of meal plate 30. Sliding bar scale 32b may be configured to manipulate the portion size of the meat (pork chop) food item of meal plate 30. Sliding bar scale 32c may be configured to manipulate the portion size of the grain (couscous) food item of meal plate 30.

The other buttons shown in FIG. 2 include a review plate button 24b, which enables the user to toggle between the menu display as shown in FIG. 2 and the meal plate display as shown in FIG. 3. Alternatively, the display of the meal plate 30 may be provided in a separate window or in a portion of the same display as the menu items. A save button 24d allows the user to save a meal selection for future use and a close button 24e allows a user to exit or abort a meal selection session.

FIG. 3 also shows two buttons 36, 38. Once the user is satisfied that the selected meal includes the items and portion sizes desired, the user may click button 36. Clicking button 36 may accept the meal. If the user decides instead that the selected meal is not desired, clicking button 38 may discard the selection. The user may then select new food items 20, restarting the process.

Once the test is completed, a researcher or the user may save the results. The result file may be opened and the results displayed by showing the photograph selected by the user for each food item. As the weight of each selected portion size of a selected food item 20 is known, and the energy density of each food item 20 is known, the energy content of the selected portion size for each selected food item 20 may be calculated. Total energy content of the meal selected may then be calculated by summing the energy content for each selected portion of meal plate 30. Total energy content may be used as the primary output value for subjective appetite. The composition of the meal may also be assessed. Assessment of the composition of the meal may provide a measure of food choice, preference and macronutrient composition.

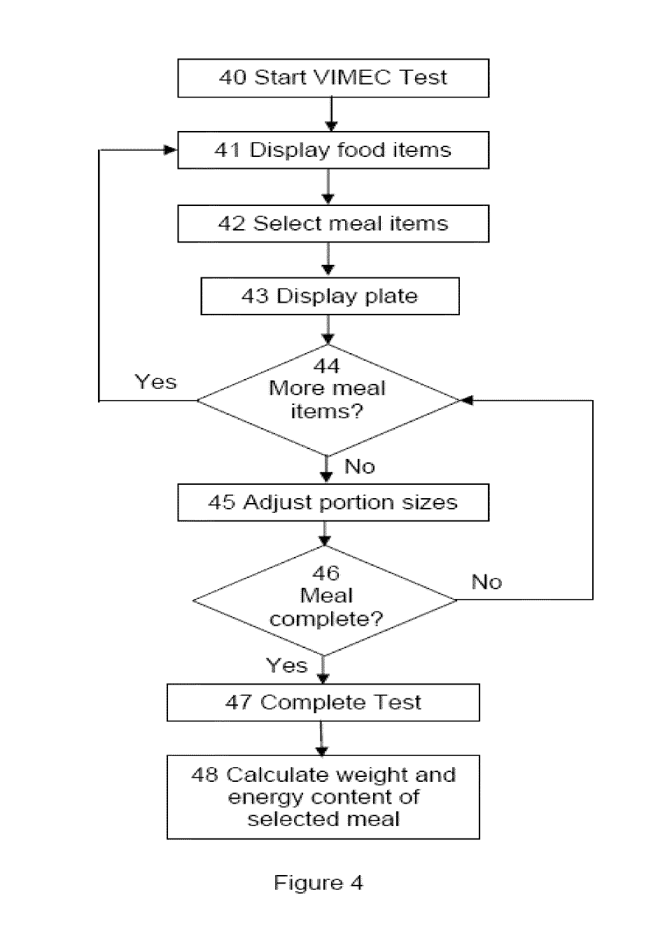

FIG. 4 is a flow chart illustrating a visual meal creator procedure. At step 40 a visual meal creator test (“VIMEC”) may be started. At step 41 food items may be displayed, for example as shown in FIG. 2. At step 42 the user may select one or more food items. At step 43, the items may be displayed on the meal plate. At step 44 the user may decide whether or not to select more items and may either return to display the food items at step 41 or proceed to step 45. At step 45 the user may adjust the portion sizes, as desired. At step 46, the user may decide if the meal is complete. If the user decides that the meal is complete, the process continues to step 47. If the user decides that the meal is not complete, the user may return to step 44 (and possibly back to step 41 if more meal items are desired). Once the test is completed at step 47, the weight and energy content of the selected meal may be calculated at step 48. The energy content may be calculated based on the known energy densities and the known weights of the selected portion sizes.

Among other benefits, a system in accordance with the disclosure may be a popular avenue for those addressing the energy balance equation. As the energy balance represents the difference between energy consumed and energy expended, the “energy in” side of the equation may be influenced greatly by appetite. In addition, the relationship between “energy out” and “energy in” may be of interest with regards to the effect of exercise on subsequent appetite sensations.

A number of techniques have been, or are currently used to assess and measure appetite. Perhaps the most intuitive measure is the objective measure of food intake, which is typically administered to obtain food, energy and nutrient intake information. This is usually obtained through ad libitum test meals, whereby the subject is presented with food and instructed to eat as much as they desire. The meal presented may be a homogenous meal of constant composition or may be a buffet-style meal, offering a range of food items. By presenting a range of food types of various compositions, the latter approach may also allow for the measure of food choice or preference. Typically, such measures are made covertly. The food is presented to the subject, having been pre-weighed. After the subject has consumed as much food as they wish, the food is removed and re-weighed, out of view of the subject. The post-meal weight of the food is subtracted from the pre-meal weight, thus obtaining the weight of food consumed. As the energy density of the food provided is known, an energy intake value can be calculated. If the buffet-style meal is used, with a range of food items, further information can be obtained, such as macronutrient composition and energy density of the total food consumption.

While a valid and commonly-used measure of appetite, energy intake measurement techniques have certain flaws. A fundamental issue with test meal measures of appetite is that repeated, independent measures may not be obtainable; the consumption of food may influence any subsequent food intake. Hence, with this technique, it is difficult to measure changes in appetite over a relative short period of time. Also, such measures are usually obtained within the laboratory, which is a rather unnatural, unfamiliar environment.

If a researcher wishes to maintain a natural setting as much as possible during measures of food intake, food diary questionnaires can be used, where the participant is free to leave the laboratory and eat under free-living conditions while recording their food intake, noting accurately the type, brands and weight of food consumed. This method however consistently yields large errors in data collection (typically under-reporting of intake) and is therefore unlikely to represent accurate measures of food intake.

Food intake in ad libitum tests can be influenced by the composition of the meal provided. If the meal is of constant composition, intake can be greatly dependent on a subject's liking for that particular food or the subject may simply get bored of consuming the same food and hence, lack of motivation to eat results in cessation of eating, as opposed to true satiation being reached. If the range of food offered is large and is all presented and made visible to the participant, they may be influenced by novel or rare food items. This will skew their food preference and may also lead to over-eating.

When independent, repeated measures of appetite are desired, measures of subjective appetite are usually recorded. While generally considered a weaker measure of appetite than objective measures, subjective measures, typically obtained with the use of visual analogue scale (“VAS”) techniques, hold some advantages over the ad libitum test meal technique. Visual analogue scale techniques are used extensively to assess individuals' perception of a wide variety of states (e.g., pain, anxiety, arousal) in both clinical and psychological research and practice. A visual analogue scale test of subjective appetite commonly consists of four questions addressing a subject's perceived appetite level. For each question, the subject answers by making a small, vertical mark on a 150 mm line which is anchored at each end by the two extreme answers to the question. The mark on the line indicates the subject's answer, or their feeling towards the question asked. The four questions, (with anchors) are: “How hungry do you feel?” (not at all hungry/the hungriest I have ever felt); “How full do you feel?” (not at all full/as full as I have ever felt); “How strong is your desire to eat?” (very weak/very strong); “How much do you think you could eat now?” (nothing at all/a large amount). The researcher then measures how far along the line (in mm) the mark was made by the subject, thus obtaining a score out of 150.

This test is very inexpensive and simple to administer. It can be completed very quickly and allows for multiple, independent repeated measures within a relatively small time frame. It has consistently been shown that visual analogue scale tests are sensitive to pharmaceutical and dietary interventions that are expected to manipulate appetite. In fact, it has been observed that visual analogue scale tests can be more sensitive to laboratory-based dietary manipulation than food intake measures, under certain ad libitum feeding conditions. Visual analogue scale tests are generally considered to demonstrate good reliability, with good day-to-day reproducibility. However, visual analogue scale exhibits large inter-subject variation, meaning that comparisons of subjective appetite using the visual analogue scale technique may be best limited to within-subject comparisons.

Visual analogue scale scales do have further limitations. Principally, they offer no additional information regarding food choice or preference. They offer a measure of subjective appetite and some prediction of crude food intake, but offer no indication of specific food preferences and no prediction of food items that a participant is likely to choose to eat. In addition, certain populations may find it harder to rationalise the scoring of a visual analogue scale. Within clinical research, more visually stimulating alternatives to the visual analogue scale have been considered for subjective measures of pain within adolescent populations.

The ability to indicate changes in food choice and preference, along with possibility for independent repeated measurements and the highly interactive, visual nature of the technique makes the visual meal creator a novel and extremely useful tool for the measurement of subjective appetite. The visual meal creator is a strong predictor of eating behaviour and therefore is a tool that is likely to prove useful within the field of appetite-regulation research.

Due to the versatility and ease of use of the visual meal creator, it has the potential for use in a number of different fields. The visual meal creator can also be used for the retrospective recording of food intake, as a replacement for, or accompanying, a conventional food diary questionnaire. The visual meal creator could also be developed as a very useful educational tool, highlighting the calorie content of foods and the importance of meal construction for weight management.

Additionally, the visual meal creator is a useful addition to a nutritionist's and dietician's arsenal of tools. It may often be necessary to monitor a client's perceived hunger throughout a day, perhaps in response to weight-loss interventions in the form of exercise bouts or dietary manipulation and calorie restriction. For the same reasons that the visual meal creator provides a useful tool in the laboratory and in appetite research, it can be used within a more applied setting, for example in a mobile application format for use on a small, hand-held device, such as a mobile phone.

Research photographs of food have been used to assist with retrospective food recall or as a reference for the estimation of habitual food intake. While investigations into the efficacy and validity of such tools has produced mixed results, it would appear that photographic images of food show potential for use in measures of habitual and retrospective food intake. Thus the visual meal creator may have dual-usage, not only as a measure of appetite and prospective food intake, but also to assist in retrospective measures of food intake, such as a tool to aid in the completion of food diary records. This would add to the visual meal creator's potential for use in the field and by nutritionists and dieticians.

Perhaps the most exciting diversification of the visual meal creator is its potential role within weight-management education. A good understanding of the calorie content of individual food items and meals is vital to the success of weight-management strategies. While many weight-loss strategies involve strict calorie restriction and monitoring of intake through a stringent dietary regimen, many individuals attempt weight-loss with little assistance and limited specificity of dietary intake. In such circumstances, dieters simply aim to “eat less” or “consume fewer calories” with little in the way of specific intake guidelines and limited quantitative monitoring of energy intake. When this is the case, the success of the strategy relies on a good understanding of the calorie content of the foods that are being consumed. In addition, such knowledge is key to avoiding weight gain. The visual meal creator may be used as a tool for educating individuals about the calorie content of food and how manipulating portion size and meal composition can influence energy intake both positively and negatively. The visual meal creator avoids the need to weigh individual food items and then do a calorie calculation based on the energy density of each food item. Many people will not bother to weigh their food or do the calculations based on what is stated on the food packaging. People are even less likely to look up an energy density when the food item does not have packaging that provides this information. The visual meal creator allows dieters to adjust the meal composition, prior to preparation, to achieve the target calorie intake. Thus, the visual, interactive nature of the visual meal creator makes it an effective tool for this knowledge transfer.

What is claimed is:

1. A device effective to generate a visual display of a meal, the device comprising:
a processor;
a memory configured in communication with the processor, wherein the memory is effective to store one or more instructions executable by the processor; and
the processor effective to, in accordance with the one or more instructions:
display images of food items on a display;
receive one or more selections of food items from among the displayed images; and
display images of the one or more selected food items on the display to generate the visual display of the meal.

2. The device of claim 1, wherein the processor is further effective to adjust a size of a portion of the one or more selected food items.

3. The device of claim 2, wherein the visual display of the meal includes an amount of a particular one of the one or more selected food items based on a user input quantity.

4. The device of claim 1, wherein the processor is further effective to calculate an amount of energy associated with the visual display of the meal.

5. A device effective to measure an appetite of a subject, the device comprising:
a processor;
a memory configured in communication with the processor, wherein the memory is effective to:
store one or more instructions executable by the processor; and
store image data of food items and an energy density value associated with each of the food items;
the processor effective to, in accordance with the one or more instructions:
display images of food items on a display;
receive one or more selections of food items from among the displayed images;
receive selections of portions of the one or more selected food items;
generate a visual display of a meal including the selected portions of the one or more selected food items; and
calculate a weight and energy content of the selected portions of the one or more selected food items based on known weights of the selected portions and the energy density values of the one or more selected food items.

6. The device of claim 5, wherein the processor is further effective to adjust the size of a portion of at least one of the one or more selected food items.

7. The device of claim 6, wherein the visual display of the meal includes an amount of a particular one of the one or more selected food items based on a user input quantity.

8. The device of claim 6, wherein the processor is effective to adjust the size of a portion of a particular one of the one or more selected food items based on a position of a sliding bar on a sliding scale, wherein the sliding bar and the sliding scale are associated with the particular one of the one or more selected food items.

9. The device of claim 5, wherein the processor is further effective to display the selected portions of the one or more selected food items in a separate window on the display.

10. The device of claim 5, wherein the processor is further effective to display the selected portions of the one or more selected food items in a separate portion of the same display as the displayed images of food items.

11. The device of claim 5, wherein the processor is further effective to generate a display that shows the selected portions of the one or more selected food items together on a plate.

12. The device of claim 5, wherein the memory is further effective to store a library of images of ascending portion sizes of each of the food items, and an associated weight for each portion size of each food item.

13. A method for measuring an appetite of a subject, the method comprising:
displaying images of food items on a display, each of the food items having an associated energy density value;
receiving a selection of one or more of the displayed food items by a user;
receiving a selection of a size of a portion of each of the one or more selected food items to produce a selected portion;
generating a visual display of a meal including the selected portions of the one or more selected food items; and
calculating a weight and energy content of the selected portions of the one or more selected food items based on known weights of the selected portions and the associated energy density values of the one or more selected food items.

14. The method of claim 13, further comprising displaying the selected portions of the one or more selected food items in a separate window.

15. The method of claim 13, further comprising displaying the selected portions of the one or more selected food items in a separate portion of the same window as the displayed images of the food items.

16. The method of claim 13, further comprising displaying the selected portions of the one or more selected food items on a plate.

17. The method of claim 13 further comprising adjusting the size of a portion of at least one of the one or more selected food items.

18. The method of claim 17, wherein adjusting the size of a portion of a particular one of the one or more selected food items is performed in response to positioning a sliding bar on a sliding scale, wherein the sliding bar and the sliding scale are associated with the particular one of the one or more selected food items.

19. The method of claim 13, further comprising displaying an amount of a particular one of the one or more selected food items based on a user input quantity.

20. The method of claim 13, further comprising discarding the visual display of the meal including the selected portions of the one or more selected food items based on input from a user.
